(19) United States
(12) Patent Application Publication
(10) Pub. No.: US 2009/0003409 A1
(43) Pub. Date: Jan. 1, 2009

(54) Temperature sensor and semiconductor memory device using the same

(75) Inventor: Mi Hyun Hwang, Anyang-si (KR)

Correspondence Address: COOPER & DUNHAM, LLP, 1185 AVENUE OF THE AMERICAS, NEW YORK, NY, 10036, US

(73) Assignee: Hynix Semiconductor Inc.

(21) Appl. No.: 12/005,708

(22) Filed: Dec. 28, 2007

(30) Foreign Application Priority Data
Jun. 27, 2007 (KR) 10-2007-0063948

(51) Int. Cl. G01K 7/00

(52) U.S. Cl. 374/170; 374/E07.001

(57) ABSTRACT

A semiconductor memory device includes a temperature sensor. The temperature sensor includes a temperature data signal generator and a temperature signal extractor. The temperature data signal generator generates temperature data signals for respective temperate ranges of internal temperature. The temperature signal extractor receives the temperature data signals and a pulse signal with a predetermined cycle, extracts the temperature data signal that is activated for at least two cycles of the pulse signal, and generates a temperature signal corresponding to the extracted temperature data signal.

### BACKGROUND

The present disclosure relates to a semiconductor memory device, and more particularly, to a temperature sensor and a semiconductor memory device using the same, which can output stable temperature data signals by screening temperature data signals outputted from a temperature sensor.

In general, a semiconductor memory device includes a temperature sensor for adjusting the operating conditions of internal circuits according to internal temperature. A conventional temperature sensor generates a temperature data signal of a digital code containing information about the internal temperature, and generates a temperature signal by reading the digital code of the temperature data signal. The temperature signal generated by the temperature sensor is used to adjust the operating conditions of the internal circuits of the semiconductor memory device. For example, the generated temperature signal is used to adjust a self-refresh cycle of a dynamic random access memory (DRAM).

The temperature signal may be generated unstably when the digital code type temperature data signal is outputted unstably. Furthermore, it is impossible to stably provide the self-refresh cycle controlled by the unstably generated temperature signal.

### SUMMARY

Embodiments of the present disclosure include a temperature sensor, and/or a semiconductor memory device using the same, which can output stable temperature data signals by screening temperature data signals outputted from a temperature sensor.

In an exemplary embodiment, a temperature sensor includes a temperature data signal generator configured to generate temperature data signals for respective temperate ranges of internal temperature, and a temperature signal extractor configured to receive the temperature data signals and a pulse signal with a predetermined cycle, extract the temperature data signal that is activated for at least two cycles of the pulse signal, and generate a temperature signal corresponding to the extracted temperature data signal.

The temperature data signal generator may generate a first temperature data signal activated when the internal temperature is within a first temperature range and a second temperature data signal activated when the internal temperature is within a second temperature range.

The temperature signal extractor may include a first temperature signal generator configured to generate a first temperature signal that is activated when the first temperature data signal is activated for at least two cycles of the pulse signal and a second temperature signal generator configured to generate a second temperature signal that is activated when the second temperature data signal is activated for at least two cycles of the pulse signal.

The first temperature signal generator may include a trigger pulse generator configured to detect the first temperature data signal in synchronization with the pulse signal and generate a trigger pulse after at least one cycle of the pulse signal from the detection point when the detected first temperature data signal is in an activated state, and a latch unit configured to latch the second temperature data signal and generate the first temperature signal in response to the trigger pulse.

The trigger pulse generator may include a transfer unit configured to transfer the first temperature data signal to a first node in response to the pulse signal, a first logic unit configured to perform a logic operation on the pulse signal and a signal of the first node, and a second logic unit configured to generate the trigger pulse by performing a logic operation on an output signal of the first logic unit and a signal obtained by delaying the output signal of the first logic unit by a predetermined time period.

The transfer unit may include a third logic unit configured to perform a logic operation on the pulse signal and the first temperature data signal, and a transfer gate configured to transfer an output signal of the third logic unit to the first node in response to the pulse signal.

The first and third logic unit may perform an AND operation and the second logic unit may perform an OR operation.

The latch unit may generate the first temperature signal that is activated when the second temperature data signal is deactivated while the trigger pulse is generated.

The temperature sensor may further include a latch configured to latch the signal of the first node.

The second temperature signal generator may include a trigger pulse generator configured to detect the second temperature data signal in synchronization with the pulse signal and generate a trigger pulse after at least one cycle of the pulse signal from the detection point when the detected second temperature data signal is in an activated state, and a latch unit configured to latch the first temperature data signal and generate the second temperature signal in response to the trigger pulse.

In another embodiment, a semiconductor memory device includes a temperature sensor configured to sample temperature data signals generated for respective temperate ranges of internal temperature in a predetermined cycle and generate a temperature signal corresponding to one of the sampled temperature data signals that is activated for a plurality of the predetermined cycles, and a refresh cycle adjuster configured to adjust a refresh cycle in response to the temperature signal.

The temperature signal extractor may receive a pulse signal to sample the temperature data signals in a cycle of the pulse signal.

### BRIEF DESCRIPTION OF THE DRAWINGS

FIG. 1 illustrates a block diagram of a temperature sensor according to an exemplary embodiment of the present disclosure.

FIG. 2 illustrates a circuit diagram of a first temperature signal generator of a temperature signal extractor in FIG. 1.

FIG. 3 illustrates a circuit diagram of a second temperature signal generator of the temperature signal extractor in FIG. 1.

FIGS. 4 and 5 illustrate timing diagrams of the first and second temperature signal generators of FIGS. 2 and 3.

FIG. 6 illustrates a block diagram of a semiconductor memory device including a temperature sensor according to another exemplary embodiment of the present disclosure.

FIG. 7 illustrates a graph of temperature signals generated by the temperature sensor in FIG. 6.

### DESCRIPTION OF EXEMPLARY EMBODIMENTS

Hereinafter, a temperature sensor and a semiconductor memory device using the same in accordance with exemplary embodiments of the present invention will be described in detail with reference to the accompanying drawings.

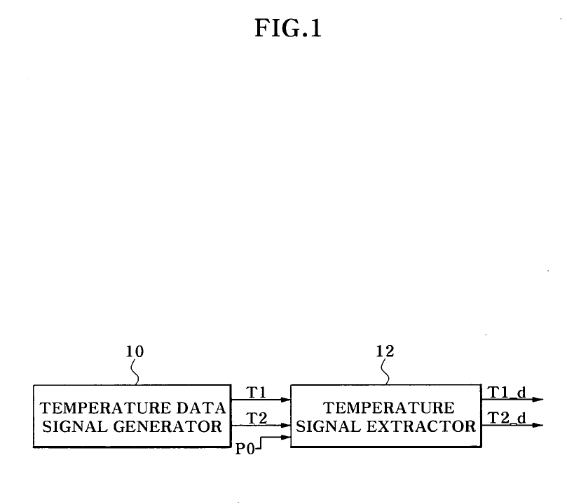

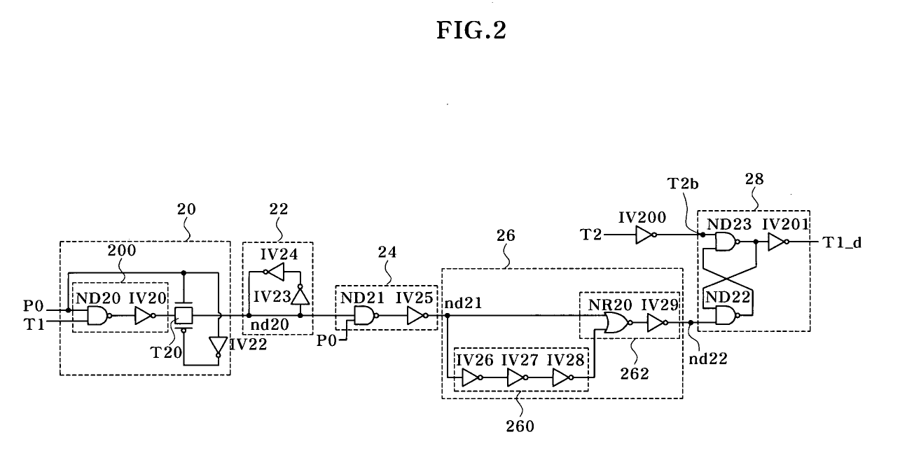

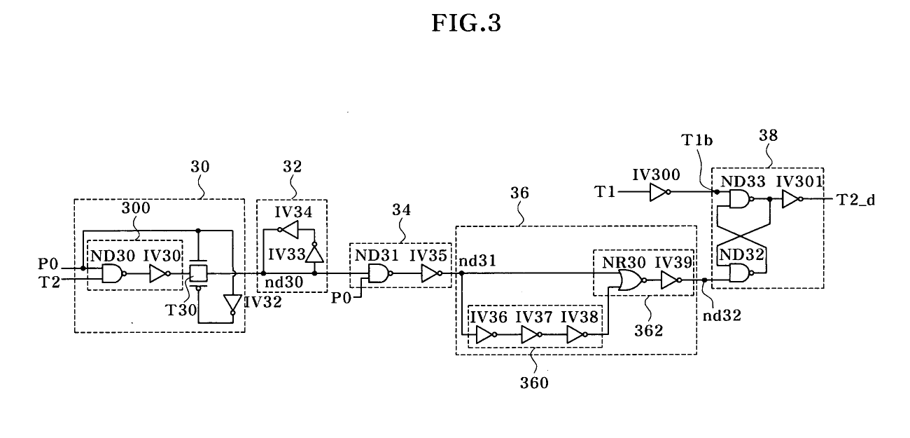

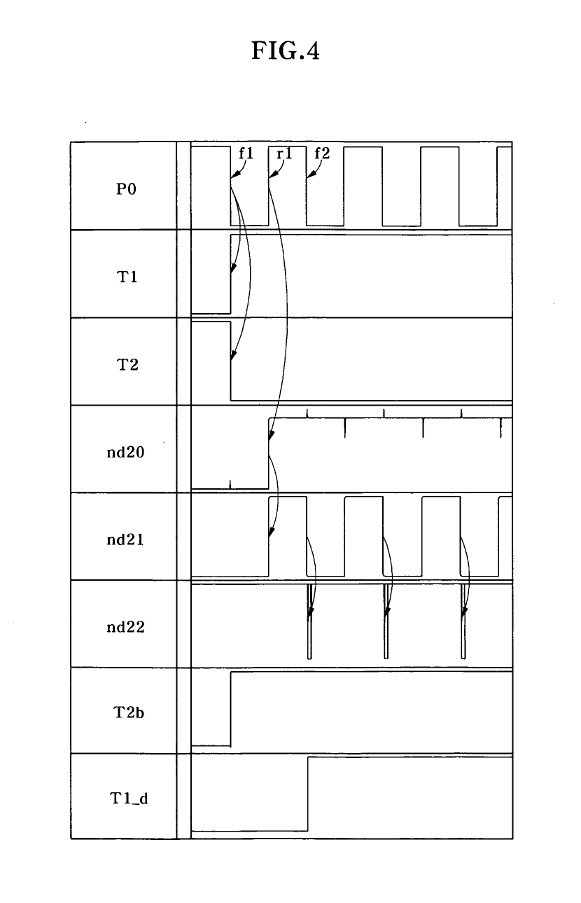

FIG. 1 illustrates a block diagram of a temperature sensor according to an exemplary embodiment of the present invention. FIG. 2 illustrates a circuit diagram of a first temperature signal generator of a temperature signal extractor in FIG. 1. FIG. 3 illustrates a circuit diagram of a second temperature signal generator of the temperature signal extractor in FIG. 1. FIGS. 4 and 5 illustrate timing diagrams of the first and second temperature signal generators of FIGS. 2 and 3.

Referring to FIG. 1, a temperature sensor according to an exemplary embodiment of the present invention includes a temperature data signal generator 10 and a temperature signal extractor 12.

The temperature data signal generator 10 generates a first temperature data signal T1 that is activated to a high level when an internal temperature of a semiconductor memory device is within a first temperature range. Also, the temperature data signal generator 10 generates a second temperature data signal T2 that is activated to a high level when the internal temperature of the semiconductor memory device is within a second temperature range. The temperature data signal generator 10 is a circuit that generates a digital code containing information about the internal temperature of the semiconductor memory device, which may be a general temperature sensor such as a band-gap reference circuit using bipolar junction transistors (BJTs).

The temperature signal extractor 12 includes a first temperature signal generator and a second temperature signal generator, each of which receives the first temperature data signal T1, the second temperature data signal T2, and a pulse signal P0. The first temperature signal generator generates a first temperature signal T1_{—}d that is activated to a high level when the first temperature data signal T1 maintains a high-level state for two-cycles of the pulse signal P0. The second temperature signal generator generates a second temperature signal T2_{—}d that is activated to a high level when the second temperature data signal T2 maintains a high-level state for two-cycles of the pulse signal P0. The pulse signal has a predetermined cycle. In this embodiment, the pulse signal P0 is set so that the first and second temperature data signals T1 and T2 are level-shifted at a falling edge of the pulse signal P0 (i.e., when the pulse signal P0 shifts from a high level to a low level). The level shift points of the first and second temperature data signals T1 and T2 may vary with embodiments.

Referring to FIG. 2, the first temperature signal generator includes a transfer unit 20, a latch 22, a logic unit 24, a trigger pulse generator 26, and a latch unit 28.

The transfer unit 20 includes a logic unit 200 and a transfer gate T20. The logic unit 200 (comprising NAND gate ND20 and inverter IV20) performs an AND operation on the pulse signal P0 and the first temperature data signal T1. The transfer gate T20 transfers the output signal of the logic unit 200 to a node nd20 in response to the pulse signal P0.

The latch 22 includes an inverter chain IV23/IV24 to latch a signal of the node nd20. The latch 22 prevents the node nd20 from floating when the transfer gate T20 is turned off. The logic unit 24 includes a NAND gate ND21 and an inverter IV25 to perform an AND operation on the pulse signal P0 and the signal of the node nd20.

The trigger pulse generator 26 includes an inverting delay unit 260 and a logic unit 262. The inverting delay unit 260 (comprising inverters IV26, IV27, IV28) delays a signal of a node nd21 for a predetermined time period and inverts the resulting signal. The logic unit 262 (comprising NOR gate NR20 and inverter IV29) performs an OR operation on the signal of the node nd21 and the output signal of the inverting delay unit 260 to output a trigger pulse to a node nd22.

The latch unit 28 includes a NAND gate latch (comprising NAND gate ND23, inverter IV201 and NAND gate ND22) that receives an inverted signal T2b of the second temperature data signal T2 and a signal of the node nd22 to generate the first temperature signal T1_{—}d.

Referring to FIG. 3, the second temperature signal generator includes a transfer unit 30, a latch 32, a logic unit 34, a trigger pulse generator 36, and a latch unit 38.

The transfer unit 30 includes a logic unit 300 and a transfer gate T30. The logic unit 300 (comprising NAND gate ND30 and inverter IV30) performs an AND operation on the pulse signal P0 and the second temperature data signal T2. The transfer gate T30 transfers the output signal of the logic unit 300 to a node nd30 in response to the pulse signal P0.

The latch 32 includes an inverter chain IV33/IV34 to latch a signal of the node nd30. The latch 32 prevents the node nd30 from floating when the transfer gate T30 is turned off. The logic unit 34 includes a NAND gate ND31 and an inverter IV35 to perform an AND operation on the pulse signal P0 and the signal of the node nd30.

The trigger pulse generator 36 includes an inverting delay unit 360 and a logic unit 362. The inverting delay unit 360 (comprising inverters IV36, IV37, IV38) delays a signal of a node nd31 for a predetermined time period and inverts the resulting signal. The logic unit 362 (comprising NOR gate NR30 and inverter IV39) performs an OR operation on the signal of the node nd31 and the output signal of the inverting delay unit 360 to output a trigger pulse to a node nd32.

The latch unit 38 includes a NAND gate latch (NAND gate ND33, inverter IV301, NAND gate ND32) that receives an inverted signal T1b of the first temperature data signal T1 and a signal of the node nd32 to generate the second temperature signal T2_{—}d.

The operations of the first and second temperature signal generators will now be described with reference to the timing diagrams of FIGS. 4 and 5. In this embodiment, it is assumed that the internal temperature of the semiconductor memory device changes between a first temperature range of from approximately 80° C. to approximately 90° C. and a second temperature range of from approximately 60° C. to approximately 80° C.

For example, a description will be given of a case where the internal temperature of the semiconductor memory device changes from the second temperature range to the first temperature range at a falling edge f1 of the pulse signal P0 and is then maintained in the first temperature range. As the internal temperature of the semiconductor memory device changes from the second temperature range to the first temperature range, the first/second temperature data signal T1/T2 shifts from a low/high level to a high/low level in synchronization with the falling edge f1 of the pulse signal P0. Thereafter, the level-shifted first temperature data signal T1 is transferred to the node nd20 in synchronization of a rising edge r1 of the pulse signal P0. That is, the level-shifted first temperature data signal T1 is delayed by a half cycle of the pulse signal P0 and is then transferred to the node nd20.

The logic unit 24 performs an AND operation on the pulse signal P0 and the signal of the node nd20 to extract/transfer the pulse signal P0 to the node nd21 while the signal of the node nd20 is in a high-level state. Thus, a pulse is generated at the node nd21 every period after the rising edge r1 of the pulse signal P0.

The trigger pulse generator 26 receives the signal of the node nd21 to generate a trigger pulse. The trigger pulse is a low pulse that is generated in synchronization with a falling edge of the pulse generated at the node nd21. The pulse width of the trigger pulse is determined by the delay period of the inverting delay unit 260. The trigger pulse is formed after the level-shifted first temperature data signal T1 is delayed by one cycle of the pulse signal P0. It has been assumed that the first temperature data signal T1 maintains a high level. Therefore, the trigger pulse is generated every cycle of the pulse signal P0 after the level-shifted first temperature data signal T1 is delayed by one cycle of the pulse signal P0. The trigger pulse means that the first temperature data signal T1 maintains a high level for the previous one cycle of the pulse signal P0 before the formation point of the trigger pulse. This means that the internal temperature of the semiconductor memory device has been within the first temperature range of from approximately 80° C. to approximately 90° C. for one cycle of the pulse signal P0 before the formation point of the trigger pulse.

The latch unit 28 latches the signal of the node nd22 and the inverted signal T2b of the second temperature data signal T2 to generate the first temperature signal T1_{—}d. The latch unit 28 generates the first temperature signal T1_{—}d with a high level when the inverted signal T2b of the second temperature data signal T2 is in a high-level state while a trigger pulse is formed at the node nd22. The high-level first temperature signal T1_{—}d means that the first/second temperature data signal T1/T2 maintains a high/low level at a falling edge f2 of the pulse signal P0. This means that the internal temperature of the semiconductor memory device has been within the first temperature range of from approximately 80° C. to approximately 90° C. for two cycles of the pulse signal P0.

At this point, because the second temperature data signal T2 fails to maintain a high-level state for two cycles of the pulse signal P0, the second temperature signal generator generates the second temperature signal T2_{—}d with a low level. The second temperature signal generator has the same structure as the first temperature signal generator, with the exception that the second temperature signal generator is different from the first temperature signal generator in terms of the input points of the first and second temperature data signals T1 and T2. Thus, a detailed description of the operation of the second temperature signal generator will be omitted in the interest of brevity.

A description will be given of another case where the internal temperature of the semiconductor memory device changes from the second temperature range to the first temperature range at the falling edge f1 of the pulse signal P0, changes from the first temperature range to the second temperature range at the falling edge f2 of the pulse signal P0, changes from the second temperature range to the first temperature range at a falling edge f3 of the pulse signal P0, and is then maintained in the first temperature range. The transfer unit 20 delays the first temperature data signal T1 by a half cycle of the pulse signal P0 and transfers the same to the node nd20. Thus, the signal of the node nd20 shifts to a high level at the rising edge r1 of the pulse signal P0, shifts to a low level at a rising edge r2 of the pulse signal P0, and shifts to a high level at a rising edge r3 of the pulse signal P0.

The logic unit 24 performs an AND operation on the pulse signal P0 and the signal of the node nd20 to extract/transfer the pulse signal P0 to the node nd21 while the signal of the node nd20 is in a high-level state. Thus, a pulse is generated at the node nd21 only for periods after the rising edge r1 and r3 of the pulse signal P0.

The trigger pulse generator 26 receives the signal of the node nd21 to generate a trigger pulse. The trigger pulse is generated in synchronization with a falling edge of the pulse generated at the node nd21. The trigger pulse is formed after the level-shifted first temperature data signal T1 is delayed by one cycle of the pulse signal P0. Thus, the trigger pulse is generated at the falling edges f2 and f4 of the pulse signal P0.

The latch unit 28 latches the signal of the node nd22 and the inverted signal T2b of the second temperature data signal T2 to generate the first temperature signal T1_{—}d. At the falling edge f1 of the pulse signal P0, the inverted signal T2b of the second temperature data signal T2 shifts to a low level and thus the first temperature signal T1_{—}d maintains a low level. This means that the internal temperature of the semiconductor memory device has been within the first temperature range of from approximately 80° C. to approximately 90° C. for only one cycle of the pulse signal P0.

At the falling edge f3 of the pulse signal P0, the inverted signal T2b of the second temperature data signal T2 maintains a high level and thus the first temperature signal T1_{—}d shifts to a high level. This means that the internal temperature of the semiconductor memory device has been within the first temperature range of from approximately 80° C. to approximately 90° C. for two cycles of the pulse signal P0.

At this point, because the second temperature data signal T2 fails to maintain a high-level state for two cycles of the pulse signal P0, the second temperature signal generator generates the second temperature signal T2_{—}d with a low level.

As described above, even when the first and second temperature data signals T1 and T2 are generated unstably because the internal temperature of the semiconductor memory device changes between the first temperature range and the second temperature range, a temperature sensor such as provided by the exemplary embodiment of the present invention discussed above generates the first and second temperature signals T1_{—}d and T2_{—}d that are activated only when the temperature data signal maintains a constant level for two cycles of the pulse signal P0. This makes it possible to screen and generate the temperature data signals stably.

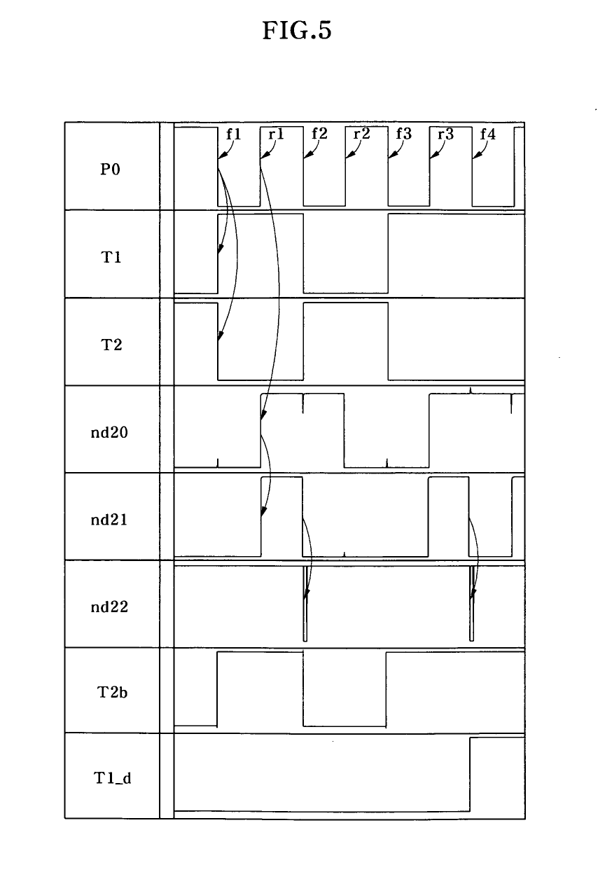

FIG. 6 illustrates a block diagram of a semiconductor memory device including a temperature sensor according to another exemplary embodiment of the present invention.

Referring to FIG. 6, a semiconductor memory device according to another exemplary embodiment of the present invention includes a temperature sensor 60 and a refresh cycle adjuster 62.

The temperature sensor 60 generates a first temperature signal T1_{—}d and a second temperature signal T2_{—}d. The first temperature signal T1_{—}d is activated to a high level when an internal temperature of a semiconductor memory device is within a first temperature range of from approximately 80° C. to approximately 90° C. for two cycles of the pulse signal P0. The second temperature signal T2_{—}d is activated to a high level when the internal temperature of a semiconductor memory device is within a second temperature range of from approximately 80° C. or less for two cycles of the pulse signal P0. To this end, the temperature sensor 60 includes a temperature data signal generator and first to second temperature signal generators. The temperature data signal generator generates first and second temperature data signals. The first to second temperature signal generators generate first and second temperature signals T1_{—}d, T2_{—}d respectively.

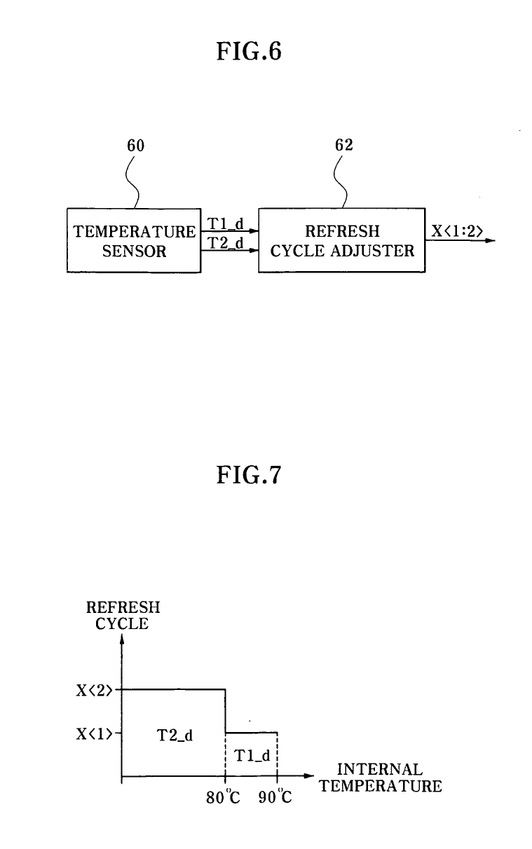

The refresh cycle adjuster 62 receives the first to second temperature signals T1_{—}d and T2_{—}d to adjust a self-refresh cycle. For example, as illustrated in FIG. 7, the self-refresh cycle is adjusted to a single cycle X<1> when the first temperature signal T1_{—}d is activated to a high level. The self-refresh cycle is adjusted to a double cycle X<2> when the second temperature signal T2_{—}d is activated to a high level. The refresh cycle adjuster 62 can be easily implemented using a general refresh cycle adjuster circuit.

A semiconductor memory device according to the present invention includes a temperature sensor that generates temperature signals containing information about the internal temperature of the semiconductor memory device only when temperature data signals are outputted at least two times, thereby providing stable self-refresh cycle.

In the above-described examples and exemplary embodiments, the temperature sensor activates and outputs the corresponding temperature signal only when the temperature data signal is outputted for two cycles of the pulse signal P0. However, the output period and level shift point of the temperature data signal may vary with various other exemplary embodiments.

As described above, a semiconductor memory device using a temperature sensor according to the present invention can provide more stable temperature data signals by screening the temperature data signals outputted from the temperature sensor.

Also, the stable self-refresh cycle can be provided by controlling the refresh cycle using the temperature data signals that are outputted stably.

While the subject matter of the present disclosure has been described with respect to the specific exemplary embodiments, it will be apparent to those skilled in the art that various changes and modifications may be made without departing from the spirit and scope of the disclosure and the following claims.

The present application claims priority to Korean patent application number 10-2007-0063948, filed on Jun. 27, 2007, which is incorporated by reference herein in its entirety.

What is claimed is:

1. A temperature sensor comprising:
a temperature data signal generator configured to generate temperature data signals for respective temperate ranges of internal temperature; and
a temperature signal extractor configured to receive the temperature data signals and a pulse signal with a predetermined cycle, extract a temperature data signal that is activated for at least two cycles of the pulse signal, and generate a temperature signal corresponding to the extracted temperature data signal.

2. The temperature sensor of claim 1, wherein the temperature data signal generator generates a first temperature data signal activated when the internal temperature is within a first temperature range and a second temperature data signal activated when the internal temperature is within a second temperature range.

3. The temperature sensor of claim 2, wherein the temperature signal extractor comprises:
a first temperature signal generator configured to generate a first temperature signal that is activated when the first temperature data signal is activated for at least two cycles of the pulse signal; and
a second temperature signal generator configured to generate a second temperature signal that is activated when the second temperature data signal is activated for at least two cycles of the pulse signal.

4. The temperature sensor of claim 3, wherein the first temperature signal generator comprises:
a trigger pulse generator configured to detect the first temperature data signal in synchronization with the pulse signal and generate a trigger pulse after at least one cycle of the pulse signal from a detection point when the detected first temperature data signal is in an activated state; and
a latch unit configured to latch the second temperature data signal and generate the first temperature signal in response to the trigger pulse.

5. The temperature sensor of claim 4, wherein the trigger pulse generator comprises:
a transfer unit configured to transfer the first temperature data signal to a first node in response to the pulse signal;
a first logic unit configured to perform a first logic operation on the pulse signal and a signal of the first node; and
a second logic unit configured to generate the trigger pulse by performing a second logic operation on an output signal of the first logic unit and a signal obtained by delaying the output signal of the first logic unit by a predetermined time period.

6. The temperature sensor of claim 5, wherein the transfer unit comprises:
a third logic unit configured to perform a third logic operation on the pulse signal and the first temperature data signal; and
a transfer gate configured to transfer an output signal of the third logic unit to the first node in response to the pulse signal.

7. The temperature sensor of claim 4, wherein the first temperature signal generated by the latch unit is activated when the second temperature data signal is deactivated while the trigger pulse is generated.

8. The temperature sensor of claim 5, further comprising a latch configured to latch the signal of the first node.

9. The temperature sensor of claim 3, wherein the second temperature signal generator comprises:
a trigger pulse generator configured to detect the second temperature data signal in synchronization with the pulse signal and generate a trigger pulse after at least one cycle of the pulse signal from a detection point when the detected second temperature data signal is in an activated state; and
a latch unit configured to latch the first temperature data signal and generate the second temperature signal in response to the trigger pulse.

10. The temperature sensor of claim 9, wherein the trigger pulse generator comprises:
a transfer unit configured to transfer the second temperature data signal to a first node in response to the pulse signal;
a first logic unit configured to perform a first logic operation on the pulse signal and a signal of the first node; and
a second logic unit configured to generate the trigger pulse by performing a second logic operation on an output signal of the first logic unit and a signal obtained by delaying the output signal of the first logic unit by a predetermined time period.

11. The temperature sensor of claim 10, wherein the transfer unit comprises:
a third logic unit configured to perform a third logic operation on the pulse signal and the second temperature data signal; and
a transfer gate configured to transfer an output signal of the third logic unit to the first node in response to the pulse signal.

12. The temperature sensor of claim 9, wherein the second temperature signal generated by the latch unit is activated when the first temperature data signal is deactivated while the trigger pulse is generated.

13. The temperature sensor of claim 10, further comprising a latch configured to latch the signal of the first node.

14. A semiconductor memory device comprising:
a temperature sensor configured to sample temperature data signals generated for respective temperate ranges of internal temperature in a predetermined cycle and generate a temperature signal corresponding to one of the sampled temperature data signals that is activated for a plurality of the predetermined cycles; and
a refresh cycle adjuster configured to adjust a refresh cycle in response to the temperature signal.

15. The semiconductor memory device of claim 14, wherein the temperature sensor receives a pulse signal to sample the temperature data signals in a cycle of the pulse signal.

16. The semiconductor memory device of claim 15, wherein the temperature data signals include a first temperature data signal activated when the internal temperature is within a first temperature range and a second temperature data signal activated when the internal temperature is within a second temperature range.

17. The semiconductor memory device of claim 16, wherein the temperature sensor comprises:
a first temperature signal generator configured to generate a first temperature signal that is activated when the first temperature data signal is activated for at least two cycles of the pulse signal; and
a second temperature signal generator configured to generate a second temperature signal that is activated when the second temperature data signal is activated for at least two cycles of the pulse signal.

18. The semiconductor memory device of claim 17, wherein the first temperature signal generator comprises:
a trigger pulse generator configured to detect the first temperature data signal in synchronization with the pulse signal and generate a trigger pulse after at least one cycle of the pulse signal from a detection point when the detected first temperature data signal is in an activated state; and
a latch unit configured to latch the second temperature data signal and generate the first temperature signal in response to the trigger pulse.

19. The semiconductor memory device of claim 18, wherein the trigger pulse generator comprises:
a transfer unit configured to transfer the first temperature data signal to a first node in response to the pulse signal;
a first logic unit configured to perform a first logic operation on the pulse signal and a signal of the first node; and
a second logic unit configured to generate the trigger pulse by performing a second logic operation on an output signal of the first logic unit and a signal obtained by delaying the output signal of the first logic unit by a predetermined time period.

20. The semiconductor memory device of claim 17, wherein the second temperature signal generator comprises:
a trigger pulse generator configured to detect the second temperature data signal in synchronization with the pulse signal and generate a trigger pulse after at least one cycle of the pulse signal from a detection point when the detected second temperature data signal is in an activated state; and
a latch unit configured to latch the first temperature data signal and generate the second temperature signal in response to the trigger pulse.

21. The semiconductor memory device of claim 20, wherein the trigger pulse generator comprises:
a transfer unit configured to transfer the second temperature data signal to a first node in response to the pulse signal;
a first logic unit configured to perform a first logic operation on the pulse signal and a signal of the first node; and
a second logic unit configured to generate the trigger pulse by performing a second logic operation on an output signal of the first logic unit and a signal obtained by delaying the output signal of the first logic unit by a predetermined time period.

22. The semiconductor memory device of claim 17, wherein the refresh cycle adjuster adjusts the refresh cycle at a predetermined value in response to the activation of the first temperature signal or the second temperature signal.
